(19) United States
(12) Patent Application Publication
(10) Pub. No.: US 2013/0334818 A1
(43) Pub. Date: Dec. 19, 2013

(54) Dynamic Braking on a Wind Turbine During a Fault

(71) Applicants: Hanif Mashal, Carpinteria, CA (US); Souleman Njoya Motapon, Manchester, CT (US)

(72) Inventors: Hanif Mashal, Carpinteria, CA (US); Souleman Njoya Motapon, Manchester, CT (US)

(73) Assignee: Clipper Windpower, LLC., Carpinteria, CA (US)

(21) Appl. No.: 13/527,249

(22) Filed: Jun. 19, 2012

(51) Int. Cl. H02P 9/10; F03D 9/00

(52) U.S. Cl. 290/44; 322/21

(57) ABSTRACT

A braking system for a wind turbine is disclosed. The braking system may include a DC chopper connected to a DC bus and a super capacitor capable of being connected to the DC chopper through a switch. The DC chopper may be controlled by a control system to enable one of charging, discharging, idle or system off modes of the super capacitor.

### FIELD OF THE DISCLOSURE

The present disclosure generally relates to wind turbines and, more particularly, relates to dynamic braking on wind turbines during fault conditions.

### BACKGROUND OF THE DISCLOSURE

As wind turbines increase in size and power, larger and larger loads are exerted on the tower and the drive train of the wind turbine during various fault conditions, such as, grid disturbances, wind gusts, and other emergency feather conditions. As a result, the tower and drive train are manufactured heavier and more structurally reinforced. While effective, this also increases the cost of the machine, both of initial manufacture, and of maintenance or when replacement is needed.

Another option is to use dynamic braking during fault conditions to help control the rotor speed of a wind turbine. This may be done in lieu of, or in addition to increasing the weight of the tower and the drive train. One common dynamic braking system uses a resistor on the DC bus, and usually a DC chopper to control the current to and power consumption of the resistor. Control of the DC chopper permits control of the amount and rate of energy absorbed by the resistor, and in turn the amount of generator braking torque created. This type of dynamic resistive braking is used in many different types of equipment and industries in addition to wind turbines, such as, electric powered mobile machinery including locomotives and electric mining trucks, etc.

Such resistive braking converts the energy instantly into large amounts of heat that must be dissipated. This in turn requires other subsystems such as cooling systems and associated controls to cool the resistors and ensure their reliable operation. Furthermore, grid disturbances that result in unloading of wind turbine generator(s) expose the wind turbines' converters/inverters to full open circuit voltage of the generator(s). To withstand such high voltages, manufacturers utilize semiconductor devices with higher voltage ratings.

Accordingly, given the numerous disadvantages associated with resistive braking, it would be beneficial if a more efficient braking system were developed. It would also be beneficial if such a braking system could be employed with lower voltage rating semiconductor devices and could be implemented in a cost effective manner.

### SUMMARY OF THE DISCLOSURE

In one aspect of the present disclosure, a braking system for a wind turbine is disclosed. The braking system may include a DC chopper connected to a DC bus and a super capacitor capable of being connected to the DC chopper through a switch.

In another aspect of the present disclosure, a method of controlling power of a wind turbine during a fault condition is disclosed. The method may comprise providing a DC chopper connected to a DC bus, a super capacitor capable of being connected to the DC chopper through a switch and a control system for controlling operation of the DC chopper. The method may also comprise receiving a control signal by the control system and enabling an operating mode of the super capacitor based upon the received signal.

In yet another aspect of the present disclosure, a wind turbine is disclosed. The wind turbine may include at least one generator connected at least indirectly to a DC bus, at least one generator control unit connected at least indirectly to the at least one generator through the DC bus and a braking system implemented within the at least one generator control unit, the braking system having a DC chopper connected to the DC bus and a super capacitor capable of being connected to the DC chopper through a switch. The wind turbine may also include a control system implemented within the at least one generator control unit, the control system to control operation of the braking system.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a circuit line diagram of a braking system employed within the wind turbine of FIG. 1;

FIG. 3 is a line diagram of a control system for controlling the braking system of FIG. 2;

FIG. 4 is a flowchart showing the steps of operation of the braking system and the control system of FIGS. 2 and 3, respectively;

FIGS. 5a-5c are exemplary graphical representations showing various electrical characteristics of a super capacitor employed within the braking system of FIG. 2 during a first charging mode of the super capacitor;

FIGS. 6a-6b are exemplary graphical representations showing power and torque changes, respectively, of a generator employed within the wind turbine of FIG. 1 during the first charging mode of the super capacitor;

FIG. 7 is an exemplary graphical representation showing changes in a DC bus voltage of the wind turbine of FIG. 1 during the first charging mode of the super capacitor;

FIGS. 8a-8c are exemplary graphical representations showing various electrical characteristics of the super capacitor during a discharge mode of the super capacitor;

FIG. 9 is an exemplary graphical representation showing changes in the generator torque during the discharge mode of the super capacitor;

FIG. 10 is an exemplary graphical representation showing changes in the DC bus voltage during the discharge mode of the super capacitor;

FIGS. 11a-11care exemplary graphical representations showing various electrical characteristics of the super capacitor during a second charging mode of the super capacitor; and

FIG. 12 is an exemplary graphical representation of the DC bus voltage during the second charging mode of the super capacitor.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

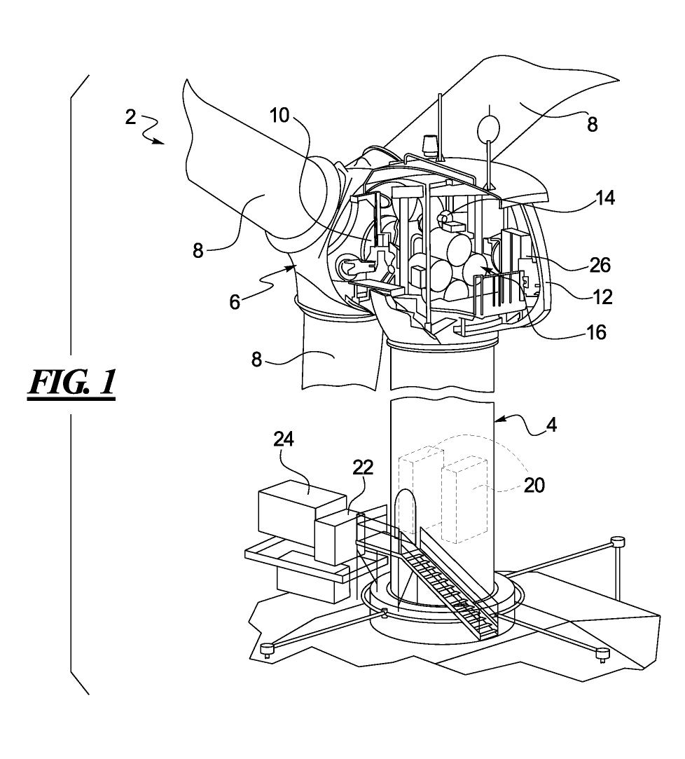

Referring to FIG. 1, an exemplary wind turbine 2 is shown, in accordance with at least some embodiments of the present disclosure. While all the components of the wind turbine have not been shown and/or described, a typical wind turbine may include a tower section 4 and a rotor 6. The rotor 6 may include a plurality of blades 8 that rotate with wind energy and transfer that energy to a main shaft 10 situated within a nacelle 12. The nacelle 12 may additionally include a low-speed shaft (not visible) driven by the main shaft 10, a gearbox 14 connecting the low speed shaft to a high speed shaft (also not visible) and, one or more generators 16 driven by the high speed shaft to generate electric current and, particularly, alternating current (AC).

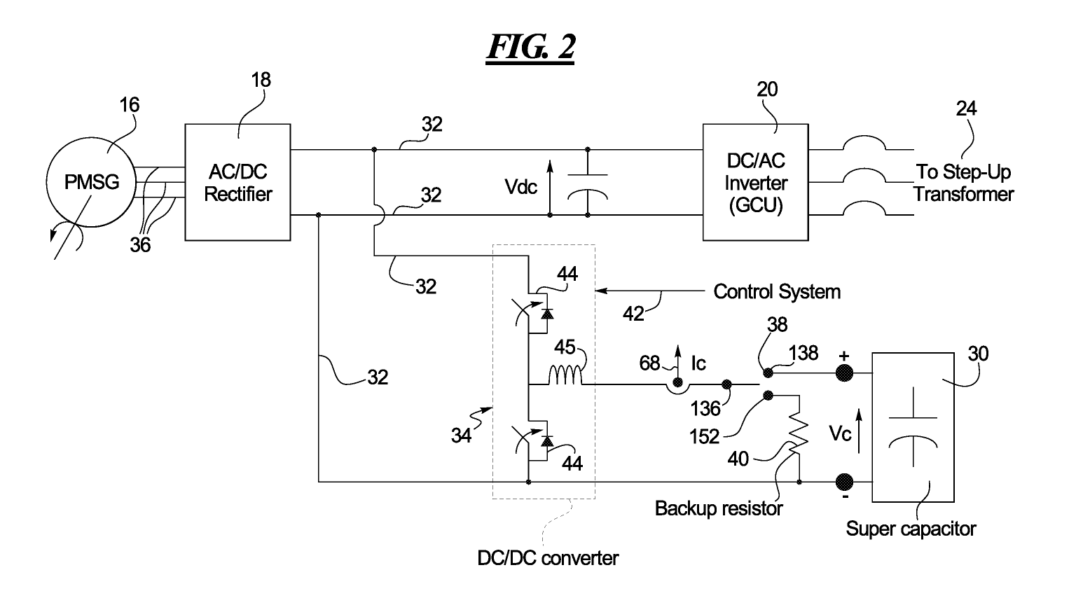

The AC current from the generators 16 may be provided to one or more rectifiers 18 (See FIG. 2) that may convert the AC current into a direct current (DC) for transmission. The rectifiers 18 may be situated within the nacelle 12 or alternatively, in at least some embodiments, may even be situated within the tower section 4. The DC current from the rectifiers 18 may be transmitted to inverters/converters situated within one or more generator control units (GCU) 20 positioned within the tower section 4. The inverters (or converters) may convert the DC current received from the rectifiers back into AC current for further transmission and distribution to a power distribution panel (PDP) 22 and a pad mount transformer (PMT) 24. From the PMT 24, the AC current may be transferred to a grid (not shown). Depending upon power load transitions (low load to high load and vice versa) at the grid, the GCUs 20 may modulate their respective inverters to generate a required AC current to meet load demands. Although not shown, it will be understood that each of the GCUs may receive several types of inputs, such as, grid voltage, power load demands, temperature ratings etc., from various components within the wind turbine 2 to compensate and modulate their respective inverters to generate varying AC output currents. The GCUs 20 and other components within the wind turbine 2 may be operated under control by a turbine control unit (TCU) 26 situated within the nacelle 12.

During a fault at the grid or other faults, such as, generator over speeding, high voltage at the DC buses (e.g., the electrical buses carrying DC current from the generators 16 and/or the rectifiers 18 to the GCUs 20), wind gusts or the like, the voltage at the output of the wind turbine 2 may be at or near zero, resulting in a very low power output of the wind turbine. With such a low power output, the generators 16 may produce very little torque, and the rotor 6 may accelerate and begin to store energy as increased rotational kinetic energy. Left uncorrected, these faults may result in over-speeding of the rotor 6 and/or the generators 16 and may risk serious damage to the wind turbine 2. Accordingly, the present disclosure provides a braking system 28, described in FIG. 2 below, that may be utilized during such fault(s) to absorb power from the generators 16, thereby allowing the generators to continue to provide some torque to the rotor 6, thereby avoiding damage to the wind turbine 2. Such a dynamic braking system in combination with controlling the speed of the rotor 6 and energy capture through pitching of the blades 8 and other actions may further ensure against rotor over-speed and damage to the wind turbine 2.

Turning now to FIG. 2, a simplified line diagram of the braking system 28 is shown, in accordance with at least some embodiments of the present disclosure. In particular, the braking system 28 may be a dynamic braking system that may include a super capacitor 30 to quickly absorb and store large amounts of energy taken from a DC bus 32 of the wind turbine 2 during a fault condition. Notwithstanding the fact that the present disclosure has been described with a super capacitor, in at least some embodiments, a bank of regular capacitors may be employed as well. A DC chopper 34 for controlling charging and discharging system of the super capacitor 30 may also be employed within the braking system 28.

Thus, as shown in FIG. 2, AC current from the generators 16 may be transmitted to the rectifiers 18 along AC lines 36. The rectifiers 18 may convert the AC current into DC current, and transmit the DC current via the DC bus 32 to the GCUs 20 and the PMT 24 during normal working conditions. During fault conditions, the DC current along the DC bus 32 may be transmitted (in addition or alternative to the GCUs 20) to the DC chopper 34, which in turn may be connected to the super capacitor 30 via a switch 38 for charging or discharging the super capacitor. A backup resistor 40 may also be connected in parallel to the super capacitor 30 to prevent over voltage and damage to the super capacitor during charging, such that if an over voltage at the super capacitor occurs, any remaining or excess charging power may be dumped and dissipated through the backup resistor.

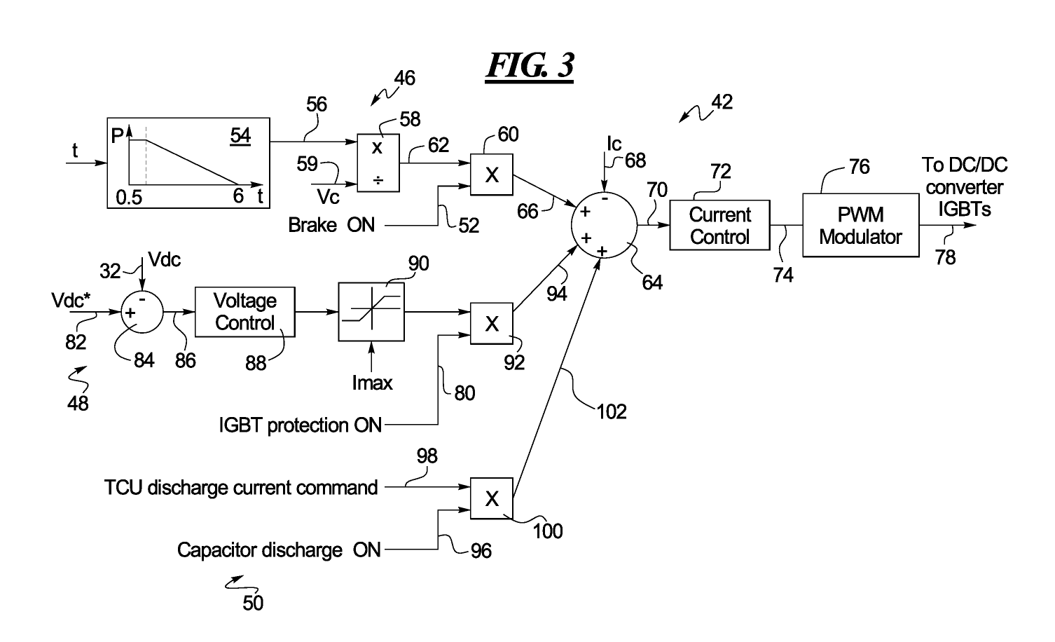

The operation of the super capacitor 30 may be controlled by the DC chopper 34, which in turn may be controlled by a control system 42, described in greater detail in FIG. 3. With respect to the DC chopper 34 in particular, it may be an electronic switched power circuit that may be employed for converting uncontrolled DC input into a controlled DC output with a desired voltage level. In at least some embodiments and, as shown, the DC chopper 34 may include two Pulse Width Modulated (PWM) semi-conductor switches 44, such as, Insulated Gate Bi-Polar Transistors (IGBTs) and a high current boost inductor 45 for controlling the charging and discharging operations of the super capacitor 30. In at least some other embodiments, one or more of the switches 44 may be Metal-Oxide-Semiconductor Field Effect Transistor (MOSFET) as well. The DC chopper 34 may be a bi-directional DC-DC converter employed for maintaining the inverters within the GCUs 20, as well as the super capacitor 30 within a safe operating area under various conditions of faults. Furthermore, the DC chopper 34 may be incorporated within the inverters of the GCUs 20 or, alternatively, it may be provided as a standalone system at the output of the generators 16.

Referring now to FIG. 3, a line diagram for the control system 42 is shown, in accordance with at least some embodiments of the present disclosure. In at least some embodiments, the control system 42 may be implemented within the GCUs 20. Furthermore, the control system 42 may provide three legs of control for controlling charging or discharging of the super capacitor 30 in conditions of grid loss, over or under voltage at the DC bus 32, generator over speeding and when the grid is back online. Thus, a first leg 46 of the control system 42 controls charging of the super capacitor 30 in conditions of grid loss and/or generator over speeding, a second leg 48 also controls charging of the super capacitor in conditions of over voltage at the DC bus 32 and/or generator over speeding, while a third leg 50 controls discharging of the super capacitor in conditions of under voltage at the DC bus or when the grid is back online Each of the three legs is described in greater detail below.

With respect to the first leg 46 of the control system 42, it provides a braking operation to the wind turbine 2 and may activate a charging mode of the super capacitor 30 to store or absorb excess energy from the generators 16. The charging mode of the super capacitor 30 may be activated when a BRAKE ON signal 52 is received. The BRAKE ON signal 52 may be provided either by the GCUs 20 or by the TCU 26. In at least some embodiments, during a generator over speeding condition, the BRAKE ON signal 52 may be issued by the TCU 26, while during a grid loss condition, the BRAKE ON signal may be issued by the GCUs 20. During the braking operation, the charging power of the super capacitor 30 may be obtained by following a power requirement curve 54 of the DC chopper 34.

Specifically, as shown, the power requirement curve 54 of the DC chopper 34 dictates that after coming online, the DC chopper may consume full power for half a second (0.5 sec) and subsequently the power may decrease linearly to ten percent (10%) at five seconds. Generally speaking, the DC chopper 34 may come online automatically as soon as one of the aforementioned faults, such as, generator over speeding and grid loss occurs or, in at least some embodiments, the DC chopper may be enabled manually as well. By virtue of the DC chopper 34 gradually decreasing from full power to ten percent power within five seconds, a smooth transition between a full load condition of the wind turbine 2 to a no load condition may be ensured.

Thus, at any instant, by utilizing the power requirement curve 54 of the DC chopper 34, a power value at that instant may be determined The power value may be input into a first summation block 58 along line 56. The first summation block 58 may also receive a voltage value V_{c} 59 of the super capacitor 30. Utilizing the power value (as transmitted along line 56) from the power requirement curve 54 and the voltage value V_{c} 59, the first summation block 58 may determine a capacitor charging current (e.g., by employing the mathematical formula: Current=Power/Voltage) and may use that current as a reference current I_{ref.} The reference current I_{ref} may be provided to a first logic block 60 along line 62. The first logic block 60 may also receive the BRAKE ON signal 52 described above. If the BRAKE ON signal 52 is ON or true (e.g., having a logic value of 1), then the reference current I_{ref} may be input into a main summation block 64 along line 66. If the BRAKE ON signal 52 is OFF or false (e.g., having a logic value of 0), then the reference current I_{ref} may not be input into the main summation block 64. By virtue of utilizing the first logic block 60, as well as other similar logic blocks (described below) in each of the first, second and third legs 46, 46 and 50, respectively, of the control system 42, it may be ensured that at any given point of time, only one of the three legs is activated and controlling the charging or discharging of the super capacitor 30.

Thus, if the BRAKE ON signal 52 is ON, the reference current I_{ref} of the super capacitor 30 may be provided along the line 66 to the main summation block 64, which may also receive current values (described below) from the second and the third legs 48 and 50, respectively, of the control system 42 in addition to a real capacitor current value I_{c} 68. It will be understood that since the control system 42 is designed such that only one of the legs 46-50 is activated at any time, the main summation block 64 may only receive a current value from the activated leg in addition to the real capacitor current value I_{c} 68. Accordingly, if the first leg 46 is activated (e.g., by the BRAKE ON signal 52 being ON), upon receiving the I_{ref} current from the first logic block 60 and the real capacitor current value I_{c} 68, the main summation block 64 may compare and determine a difference between those two current values, and provide that value along a line 70 to a current controller 72.

Based upon the current value received along the line 70 from the main summation block 64, the current controller 72 may determine a duty cycle of the switches 44 of the DC chopper 34, which may then be input along line 74 to a Pulse Width Modulator (PWM) 76. The PWM modulator 76 may then compare the duty cycle output from the current controller 72 with triangular carrier signals to generate a required PWM signal 78, which may then be input into the DC chopper 34 to regulate the voltage at the DC chopper 34 and to control charging of the super capacitor 30.

Turning now to the second leg 48 of the control system 42, this leg also activates a charging mode of the super capacitor 30 when the DC voltage V_{dc} on the DC bus 32 is above a maximum set threshold voltage V_{dc}* (e.g., 1600V-1700V). Accordingly, the second leg 48, which protects the inverters/converters within the GCUs 20 from high DC voltage from the DC bus 32 and prevents damage thereto, may be termed as an inverter protection mode (or converter protection mode). In contrast to the first leg 46, which is activated upon receiving the BRAKE ON signal 52 from either the GCUs 20 or the TCU 26, the second leg 48 may be activated upon receiving an IGBT protection ON signal 80 generated by the GCUs 20 .

Thus, if the DC voltage V_{dc} on the DC bus 32 is above a certain pre-set threshold (V_{dc}*), and if the IGBT protection ON signal 80 is ON, the second leg 48 may be activated. The voltage values of V_{dc} and V_{ac}* are input along the DC bus 32 and input line 82, respectively, into a second summation block 84. The second summation block 84 compares and determines a difference between the two (V_{dc} and V_{dc}*) voltage values and provides the difference value along line 86 to a voltage controller 88. The voltage controller 88 may provide a reference current I_{ref} for charging the super capacitor 30, which may be limited to the maximum capacitor charging current Iₘₐₓ, as shown by a saturation block 90. Specifically, due to a large difference between V_{dc} and V_{dc}*, the voltage controller 88 may tend to provide a high reference current I_{ref}, which may be greater than the maximum current Iₘₐₓ the super capacitor 30 can handle. As this high current I_{ref} could destroy the super capacitor 30, the saturation block 90 may be used to limit the reference current I_{ref} provided by the voltage controller 88 to Iₘₐₓ. The saturation block 90, thus, takes as input the maximum charging current (which may be obtained by dividing the maximum super capacitor 30 charging power by the real super capacitor voltage) and if the reference current Iₘₐₓ from the voltage controller 88 is above Iₘₐₓ, the saturation block 90 may provide Iₘₐₓ as output current. The output current from the block 90, as well as the IGBT protection ON signal 80 may then be input into a second logic block 92, which similar to the first logic block 60, may ensure that only one of the legs 46-50 is activated at a time.

If the IGBT protection ON signal 80 is ON or true (e.g., having a logic value of 1), then the second logic block 92 may provide the current value from the block 90 to the main summation block 64 along line 94. Upon receiving the current value along the line 94 and the real capacitor current value I_{c} 68, the main summation block 64 may compare and determine a difference between those current values and provides that difference value to the current controller 72 along the line 70, as discussed above. As also discussed above, the current controller 72 may then determine a duty cycle of the switches 44 of the DC chopper 34 and the PWM modulator 76 may generate the PWM signal 78 for controlling the DC chopper and charging of the super capacitor 30. Thus, the second leg 48 may serve to protect the inverters/converters within the GCUs 20 from over voltage by maintaining the DC voltage V_{dc} on the DC bus 32 below a maximum level (V_{dc}*) using the voltage controller 88.

Now, with respect to the third leg 50 of the control system 42, it may provide a discharging mode to control discharging of the super capacitor 30 under control by the GCUs 20 or the TCU 26. The discharging mode may be activated when a Capacitor Discharge ON signal 96 is received either from the TCU 26 or the GCUs 20. Specifically, when the grid is back online, the GCUs 20 may issue the Capacitor Discharge ON signal 96 to discharge the super capacitor 30 and transfer the energy from the super capacitor to the grid, thereby allowing regenerative braking. On the other hand, when the DC voltage V_{dc} is less than a minimum allowable level Vₘᵢₙ (e.g., due to generator overcharge or power outage), the discharge of the super capacitor 30 may be activated by the TCU 26 to assist the wind turbine 2 by providing the extra energy needed.

Thus, the Capacitor Discharge ON signal 96 and a TCU discharge current command 98 may be provided to a third logic block 100. The TCU discharge current command 98 may provide the reference current I_{ref} for the main summation block 64. Therefore, if the Capacitor Discharge ON signal 96 is ON or true (e.g., having a logic value of 1), then the third logic block 100 may provide the I_{ref} current value to the main summation block 64 along a line 102. On the other hand, if the Capacitor Discharge ON signal 96 is OFF or false (e.g., having a logic value of 0), then the third logic block 100 may not provide the I_{ref} current value to the main summation block 64, again to ensure that only one of the legs 46-50 is activated at any time.

Then, as discussed above, the main summation block 64 may compare and determine a difference between the I_{ref} and the real capacitor current value I_{c} 68, which is then provided to the current controller 72 along the line 70. The current controller 72 may then determine the duty cycle of the switches 44 of the DC chopper 34 and the PWM modulator 76 may determine the PWM signal 78, which may then be utilized to control the DC chopper 34 and discharge the super capacitor 30. During the discharging mode, the power to the inverters/converters within the GCUs 20 may be provided by the generators 16, as well as by the super capacitor 30 through the DC chopper 34. When the super capacitor 30 discharges to around 50% of its stored energy, the super capacitor may enter an idle mode and may wait for the next charging mode cycle. The rate of discharge from the super capacitor 30 is generally the same as the rate of charging to provide for smooth torque variation, as mentioned above.

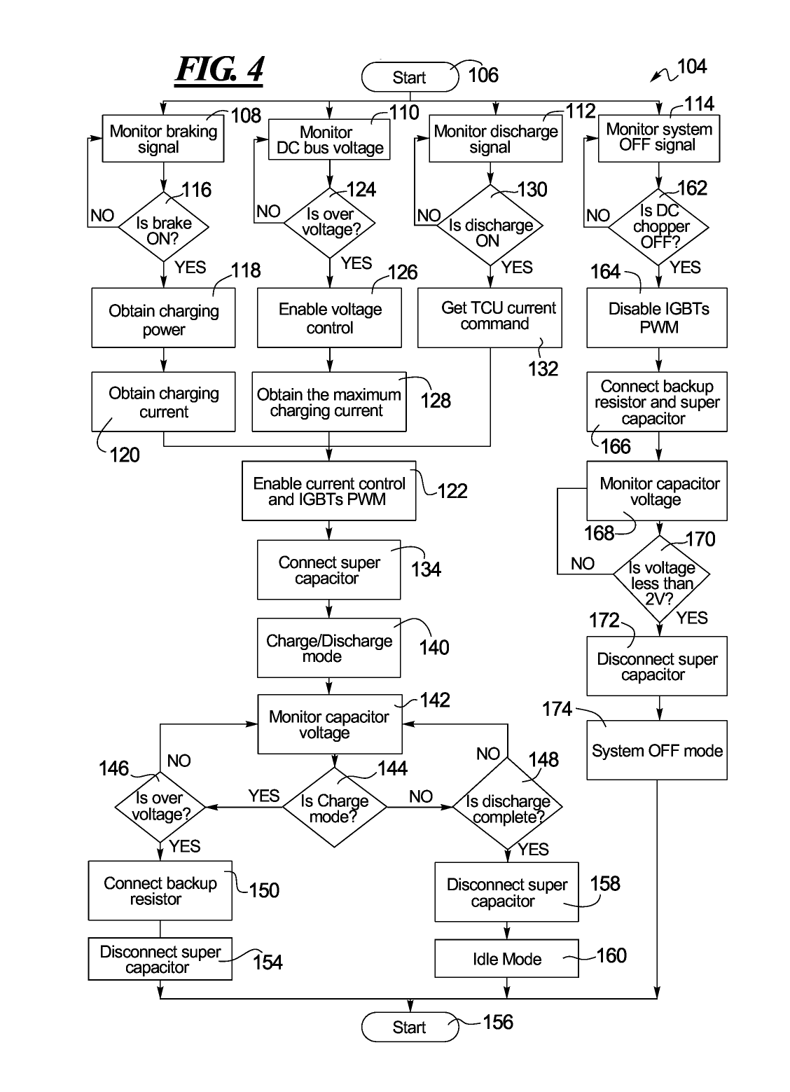

Therefore, the control system 42 provides three operating modes of the super capacitor 30, namely, a charging mode (the first leg 46 and the second leg 48), a discharging mode (the third leg 50) and an idle mode (also represented by the third leg). In addition to the aforementioned operating modes, the control system 42 may also provide for a system off mode, in which the super capacitor 30 may be discharged before turning off, as will be described further below with respect to FIG. 4.

Referring now to FIG. 4, a flowchart 104 describing the operation of the control system 42 is shown, in accordance with at least some embodiments of the present disclosure. As shown, after starting at a step 106, the process may proceed to steps 108, 110, 112 and 114, each of which may represent a control signal that is monitored by the control system 42 and based upon the control signal, the control system may activate one of the four modes of the super capacitor 30 discussed above. Specifically, the step 108 represents the BRAKE ON signal 52, corresponding to the first leg 46 of the control system 42 described above, while the step 110 represents the IGBT protection ON signal 80 to monitor the DC voltage V_{dc} on the DC bus 32 and corresponds to the second leg 48 of the control system. Relatedly, the step 112 relates to the Capacitor Discharge ON signal 96 corresponding to the third leg 50 of the control system 42, while the step 114 relates to a SYSTEM OFF signal for enabling the system off mode of the super capacitor 30, as discussed above. It will be understood that although the system off mode of the super capacitor 30 has not been shown in the control system 42 of FIG. 3, it is indeed controlled by the control system.

Thus, from the step 108, the process proceeds to a step 116, where the control system 42 may monitor the GCUs 20 and the TCU 26 to determine when the BRAKE ON signal 52 is received. If the BRAKE ON signal 52 has indeed been received (e.g., has a value of 1), then at steps 118 and 120, the control system 42 obtains the charging power and charging current, respectively, for charging the super capacitor 30, as described above in relation to the first leg 46 of the control system and further described below. If at the step 116, the control system 42 determines that the BRAKE ON signal 52 has not been received (e.g., has a value of 0), then the process loops back to the step 108 and the control system continues to monitor the GCUs 20 and the TCU 26 for the BRAKE ON signal 52.

Upon receiving the BRAKE ON signal 52 at the step 116, the control system 42 determines the value of the charging power from the power requirement curve 54 and utilizes that value to determine the capacitor charging current (e.g., by using the formula: power=voltage* current) at the step 120. After calculating the charging power and charging current, the current controller 72 and the PWM modulator 76 may be activated at the step 122, as will be described below.

On the other hand, from the step 110, if the IGBT protection ON signal 80 is received (e.g., by having a value of 1) by the control system 42 at a step 124 from the GCUs 20, then the control system determines whether the DC voltage V_{dc} on the DC bus 32 is over a maximum threshold voltage value of V_{dc}^{*}. If so, the control system 42 at a step 126 may enable voltage control by the voltage controller 88 and may obtain a maximum charging current Iₘₐₓ for charging the super capacitor 30 at a step 128, which may then be provided to the current controller 72 and the PWM modulator 76 for controlling charging of the super capacitor 30 at the step 122. In contrast, if the DC voltage V_{dc} at the DC bus 32 is not over the threshold voltage value of V_{ac}*, then the control system 42 may go back to the step 110 and continue monitoring the TCU 26 for the IGBT Protection ON signal 80.

Relatedly, if from the step 112, the control system 42 at a step 130 determines that the Capacitor Discharge ON signal 96 has been received (e.g., by having a value of 1), then at a step 132, the control system obtains the TCU discharge current command 98 for providing the reference current I_{ref} for controlling the current controller 72 and the PWM modulator 76 at the step 122. If the Capacitor Discharge ON signal 96 is not received at the step 130, then the control system 42 continues to monitor the GCUs 20 and the TCU 26 for the signal at the step 112.

Thus, the process may reach the step 122 from any of the steps 108, 110 or 112 corresponding to receiving the BRAKE ON signal 52, the IGBT protection ON signal 80 or the Capacitor Discharge ON signal 96, respectively. At the step 122, the current controller 72 may determine the duty cycle of the switches 44 of the DC chopper 34 as mentioned above, which may then be provided to the PWM modulator 76 to generate the PWM signal 78 for controlling and activating the DC chopper 34, as well as the super capacitor 30. Next, at a step 134, the super capacitor 30 may be connected to the DC chopper 34. As will be best understood by referring to FIG. 2, the super capacitor 30 may be connected to the DC chopper by way of the switch 38 and particularly, by connecting a terminal 136 of the switch 38 to a terminal 138 thereof.

Subsequent to connecting the super capacitor 30 to the DC chopper 34 at the step 134, at a step 140, the super capacitor may be geared into a charging or a discharging mode. Specifically, depending upon the control signal received at the steps 108-112, the charging or discharging mode of the super capacitor may be determined For example, if the control system 42 receives either the BRAKE ON signal 52 or the IGBT protection ON signal 80 from the steps 108 or 110, respectively, then the super capacitor 30 may be geared into the charging mode. In contrast, if the control system 42 receives the Capacitor Discharge ON signal 96 from the step 112, then the super capacitor 30 may be geared into the discharge mode.

Accordingly, based upon the control signal received by the control system 42, the super capacitor 30 may be charged or discharged at the step 140. As the super capacitor 30 is charged or discharged at the step 140, the voltage V_{c} of the super capacitor may be constantly monitored by the control system 42. Specifically, during the charging mode, the voltage V_{c} of the super capacitor 30 may be monitored to prevent over voltage at the super capacitor, as discussed below, or if in the discharging mode, the voltage V_{c} may be monitored to determine when to stop discharging. Thus, if at a step 144, the control system 42 determines that the super capacitor 30 is in a charging mode, it continues to monitor the voltage V_{c} of the super capacitor for over voltage at a step 146. On the other hand, if the control system 42 at the step 144 determines that the super capacitor 30 is in a discharging mode, then at a step 148, the control system continues to monitor the voltage V_{c} to determine when the discharging is complete.

Specifically, at the step 146, the control system 42 monitors the voltage V_{c} of the super capacitor 30 against the maximum voltage V_{cmax} of the super capacitor. If the voltage V_{c} is less than V_{cmax}, then the control system 42 may continue to charge the super capacitor 30 in accordance with the steps 118, 120, 122, 134 and 140 and may loop back to the step 142 to continue monitoring the voltage V_{c}. On the other hand, if at the step 146, the control system 42 determines that voltage V_{c} of the super capacitor 30 is indeed equal to or greater than the maximum voltage V_{cmax} of the super capacitor, then at a step 150, the control system may disconnect the super capacitor from the DC chopper 34 and may connect the backup resistor 40.

The backup resistor 40 may be connected to the DC chopper 34 by swapping the terminals of the switch 38, such that the terminal 136 of the switch is now connected to a terminal 152 thereof. Once the backup resistor 40 is connected to the DC chopper 34, the super capacitor 30 may be disconnected from the DC chopper at a step 154. It will be understood that the switching of the switch 38 to the backup resistor 40 from the super capacitor 30 may be facilitated automatically in some embodiments or, alternatively, may be facilitated manually in other embodiments.

By virtue of connecting the backup resistor 40 to the DC chopper 34, over voltage at the super capacitor 30 during charging may be prevented by dumping any remaining additional power to the backup resistor for dissipation in the form of heat, thereby ensuring that the super capacitor continues to operate within its safe operating area. In at least some embodiments, the usage of the backup resistor 40 may be avoided if the state of charge of the super capacitor 30 is well controlled. For example, if an accurate knowledge of the braking time, as well as the rate of occurrence of braking is known, then the super capacitor 30 may be sized to ensure operation in its safe operating area, thereby eliminating the backup resistor 40. The process then ends at a step 156.

Now, if the control system 42 at the step 144 determines that the super capacitor 30 is in a discharging mode (e.g., due to under voltage at the DC bus 32, or when the grid is back online after a loss), at the step 148, the control system monitors the voltage V_{c} of the super capacitor to determine when discharge is complete. As discussed above, in the discharging mode, the super capacitor 30 may be discharged to about fifty percent (50%) of its charged voltage. Once the super capacitor 30 is discharged to the fifty percent value, then the super capacitor may be disconnected from the DC chopper 34 (e.g., by braking the contact of the terminals 136 and 138 of the switch 38) at a step 158 and the super capacitor may enter an idle mode at a step 160 waiting for the next charge cycle to happen. The process then ends at the step 156. If at the step 148, the control system 42 determines that the super capacitor 30 has not completed discharge (e.g., has not discharged to fifty percent of its current value), then the control system may loop back to the step 142 to continue monitoring the voltage V_{c} of the super capacitor.

Thus, in the discharging mode, the flow of current may be from the super capacitor through the DC chopper 34 to the DC bus 32 (e.g., to the inverters in the GCUs 20), while during charging mode, the current may flow through the DC chopper in the opposite direction, i.e., from the DC bus to the super capacitor. Thus, the DC chopper 34 is a bi-directional DC chopper facilitating flow of current in both directions.

In addition to the charging, discharging and idle modes discussed above, the super capacitor 30 may also be turned off in a system off mode. The system off mode may be triggered by the SYSTEM OFF signal represented by the step 114. When the SYSTEM OFF signal is received by the control system 42, then at a step 162, the control system may determine whether the DC chopper 34 has been turned off. The DC chopper 34 may be turned off automatically upon receipt of the SYSTEM OFF signal or, alternatively, turning of the DC chopper may signify receipt of the SYSTEM OFF signal. In any event, if the DC chopper 34 is not turned off at the step 162, then the control system 42 may loop back to the step 114 and may wait for the SYSTEM OFF signal. On the other hand, if at the step 162, the control system 42 determines that the DC chopper 34 is indeed off, then at a step 164, the control system may disable the PWM modulator 76 and at a step 166, the backup resistor 40 may be connected to the super capacitor 30. In at least some embodiments, the backup resistor 40 and the super capacitor 30 may be connected by contacting the terminals 138 and 152 of the switch 38.

By virtue of connecting the backup resistor 40 to the super capacitor 30, the super capacitor may be discharged through the backup resistor such that energy stored within the super capacitor may be dissipated through the backup resistor as heat. The discharge of the super capacitor 30 continues until a low voltage of around two volts (2V) across the super capacitor is obtained. At a step 168, the control system 42 continuously monitors the voltage of the super capacitor 30 and at step 170 determines whether the voltage V_{c} of the super capacitor is less than or equal to two volts or not. If the voltage V_{c} of the super capacitor 30 has been discharged to less than or equal to two volts, then the super capacitor may be disconnected from the backup resistor 40 at a step 172 and the braking system 28 (and the super capacitor) may enter a system off mode. The system off mode may be employed during maintenance to ensure safety and prevent any mishaps. The process then ends at the step 156.

Thus, the super capacitor 30 may operate in four modes, each of which is summarized below:

Charging Mode: This mode of operation may be initiated if braking is required or as soon as the DC bus voltage rises above a fixed threshold voltage (e.g., 1600 V-1700 V), indicating a grid fault or generator over speed. During the charging mode, the DC voltage V_{dc} of the DC bus 32 may be higher than the voltage V_{c} of the super capacitor 30 and the bidirectional DC chopper 34 may act as a buck converter, charging the capacitor. The charging current and rate of the super capacitor 30 may be obtained from the power requirement curve 54 of the DC chopper 34, which may ensure a smooth torque transition from full load to no load. The maximum charge voltage V_{cmax} of the super capacitor 30 may be kept below the threshold voltage of the DC bus 32 to allow the discharge of the super capacitor when the grid fault is cleared. The charging mode may also be periodically tested during normal operating condition to ensure proper operation of the braking system 28 to absorb the braking energy.

Discharging Mode: When the grid is back online or when the DC voltage V_{dc} on the DC bus 32 is less than a specific value, the discharge mode of the super capacitor 30 may be initiated to allow the super capacitor to discharge and be ready for the next braking cycle. The rate of the discharge current and its maximum value may be provided by the TCU 26 to ensure a smooth torque variation. During the discharging mode, the voltage V_{c} of the super capacitor 30 may be lower than the DC voltage V_{dc} of the DC bus 32 and the bidirectional DC chopper 34 may operate as a boost converter, thereby discharging the capacitor.

Idle Mode: After the super capacitor 30 is discharged and until it regains its ability to store the required braking energy, the super capacitor may be switched off and the braking system 28 (and the super capacitor) may be turned in to an idle mode.

System Off Mode: When the super capacitor 30 is fully discharged through the backup resistor 40 to guarantee the safety during servicing of the GCUs 20 or any other electrical component, the super capacitor and the braking system 28 may enter the system off mode.

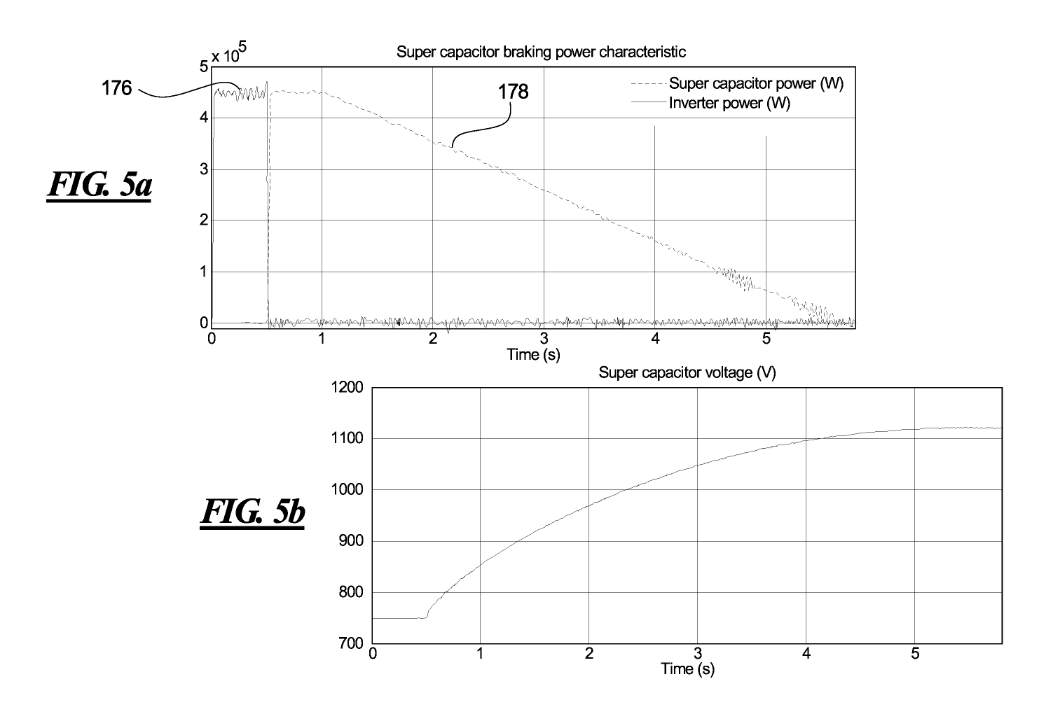

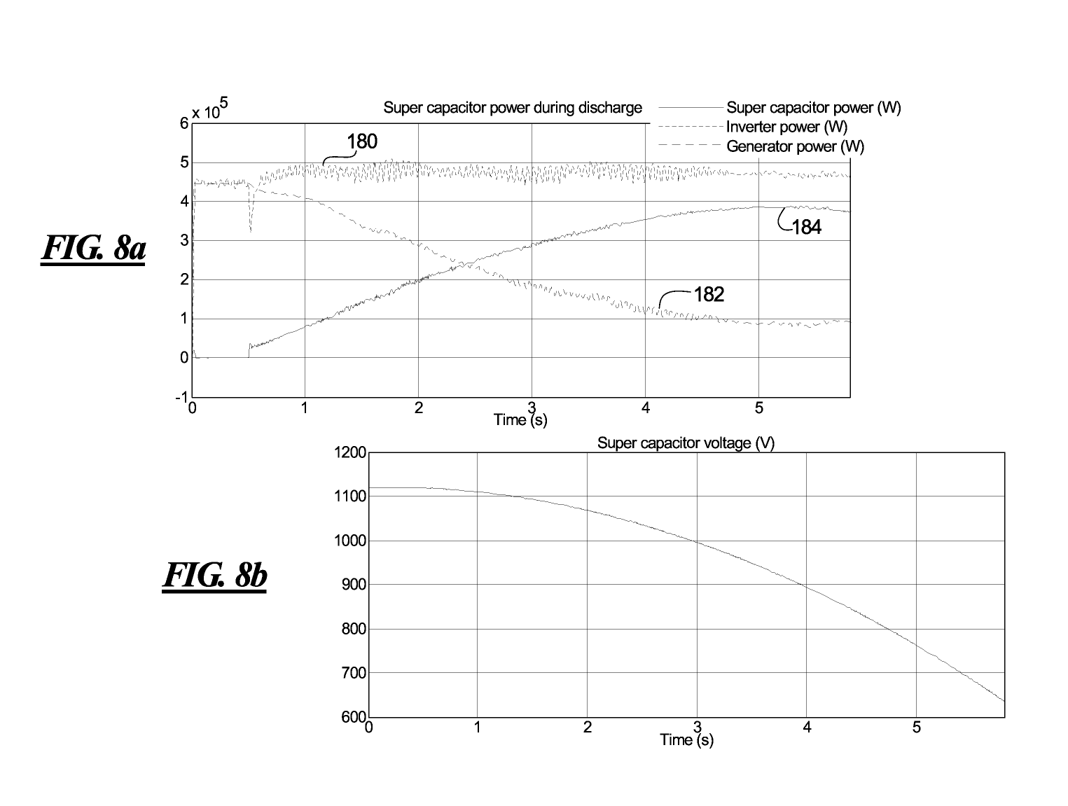

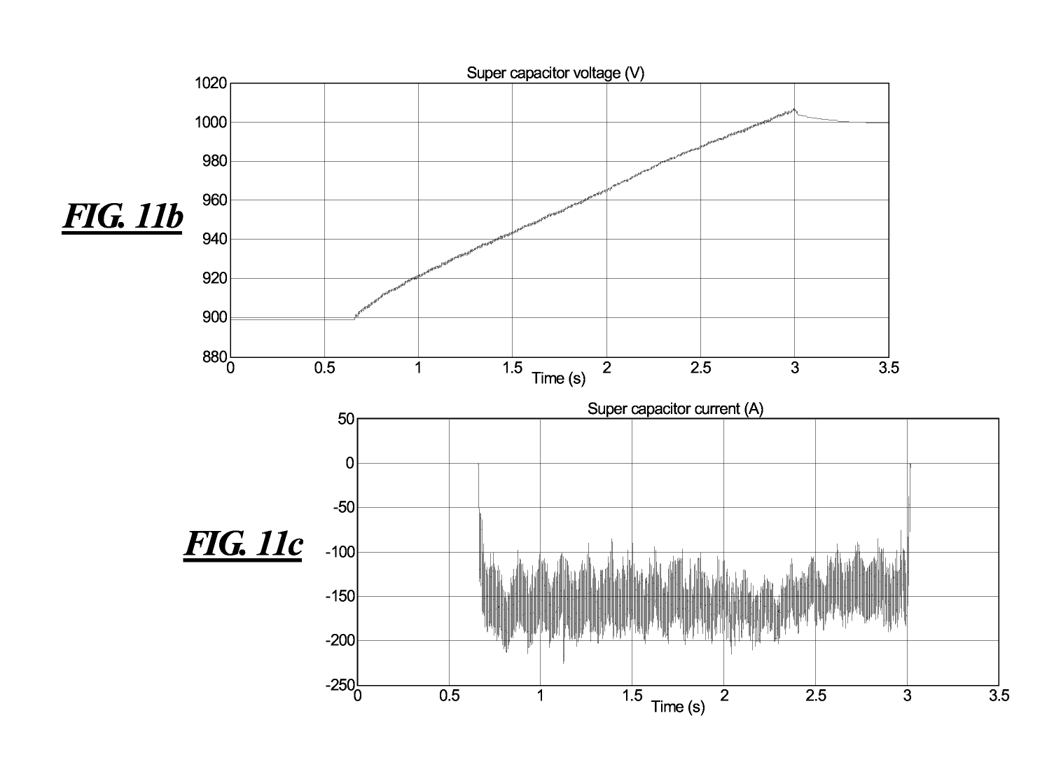

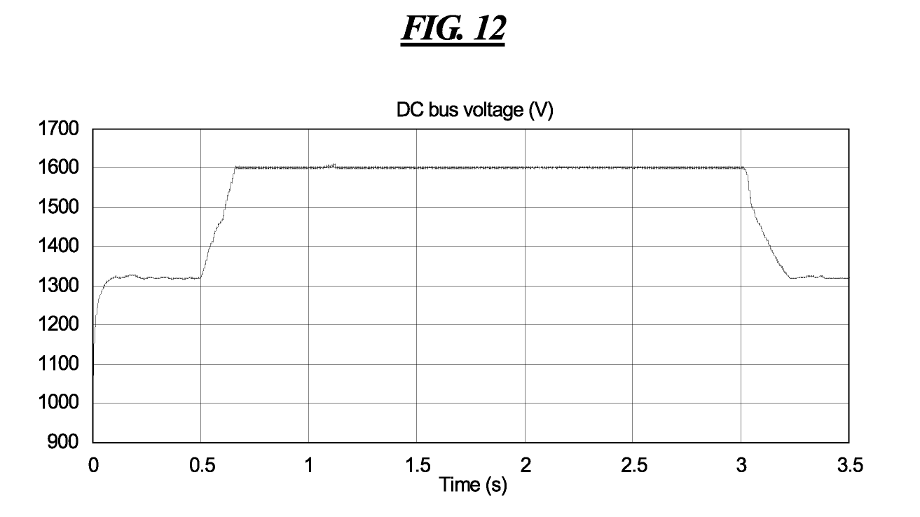

Referring now to FIGS. 5A-12, exemplary graphical representations to illustrate various electrical characteristics of the super capacitor 30, the generators 16 and the DC bus 32 are shown, in accordance with at least some embodiments of the present disclosure. Specifically, FIGS. 5A-7 illustrate electrical characteristics of the aforementioned components during a braking operation when the super capacitor 30 is operating in a charging mode, while FIGS. 8A-10 show the electrical characteristics during the discharging mode of the super capacitor. Relatedly, FIGS. 11A-12 show the electrical characteristics of the super capacitor 30 and the DC bus 32 during the inverter protection mode (over voltage of the DC bus).

Turning now to FIGS. 5A-5C, power, voltage and current characteristics, respectively, of the super capacitor 30 are shown. Referring specifically to FIG. 5A, the graph shows time on the X-Axis and power in Watts (W) on the Y-Axis. A first plot 176 shows that during a grid loss, the power from the inverters within the GCUs 20 drops from full power at zero seconds to substantially zero power at half a second (0.5 sec). In the same time, the power of the super capacitor 30 increases. Particularly, as soon as the braking system 28 experiences a grid loss, the DC chopper 34 comes online and the starts charging the super capacitor 30. Thus, a plot 178 shows that the power of the super capacitor 30 increases from substantially zero power at zero seconds to full power at half a second. After half a second, the DC chopper 34 (and hence the super capacitor 30) consumes full power for another half a seconds and then gradually decreases to about ten percent within five seconds to ensure smooth torque variation and braking in accordance with the power requirement curve 54 of the DC chopper.

Relatedly, FIG. 5B plots time on the X-Axis and voltage V_{c} in volts of the super capacitor 30 along the Y-axis. As shown, the voltage V_{c} of the super capacitor 30 may be maintained at a substantially constant value (from the previous discharge cycle) for the first half a second after grid loss. After half a second of the grid loss, when charging of the super capacitor 30 begins, the voltage increases exponentially until getting closer to its maximum rated value of voltage V_{cmax}. At that point, as discussed above, the backup resistor 40 may be connected to dissipate any residual power. FIG. 5C on the other hand plots time on the X-Axis and current in Amperes (A) on the Y-Axis. As shown, after charging begins at half a second of grid loss, the current of the super capacitor 30 increases as well (in accordance with Ohm's Law, which states that voltage is directly proportional to current).

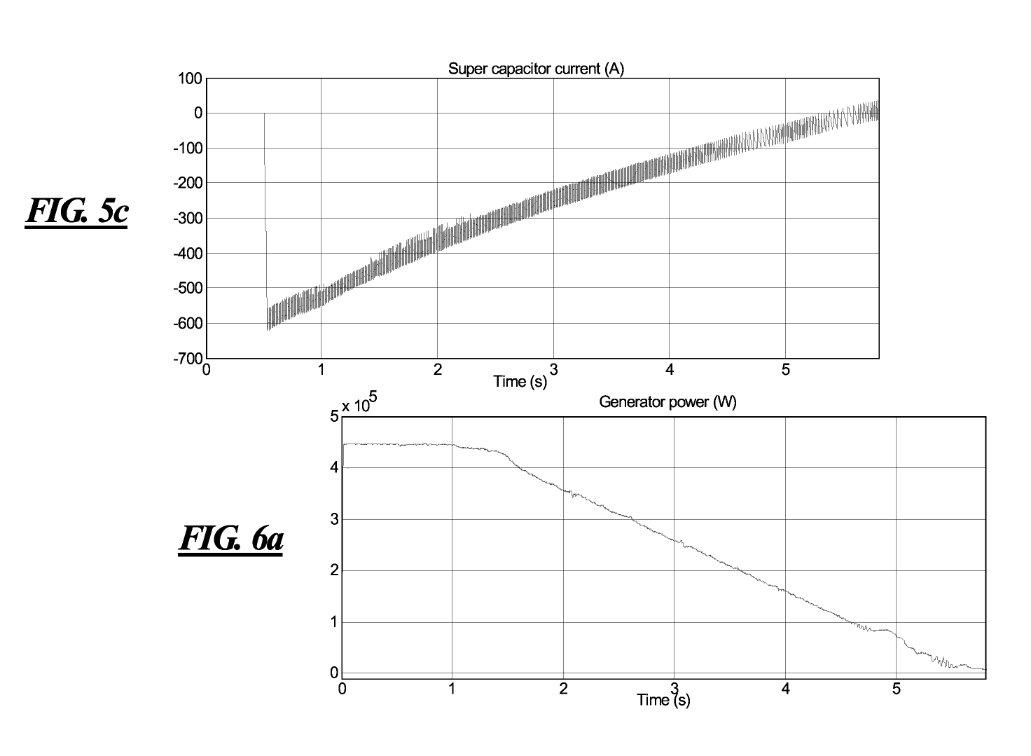

Turning now to FIGS. 6A and 6B, power and torque characteristics of the generators 16, respectively, are shown. FIG. 6A plots time in seconds on the X-Axis against power in Watts (W) on the Y-Axis, while FIG. 6B also plots time in seconds on the X-Axis and torque in Newton-Meter (N.M) on the Y-Axis. Each of the above plots show that for about a second (including the half a second when the DC chopper 34 consumes full power) after grid loss, the generator maintains its power, as well as torque. Then after that, when the braking system 28 comes online, the power and torque of the generators 16 reduce substantially linearly to about ten percent at five seconds.

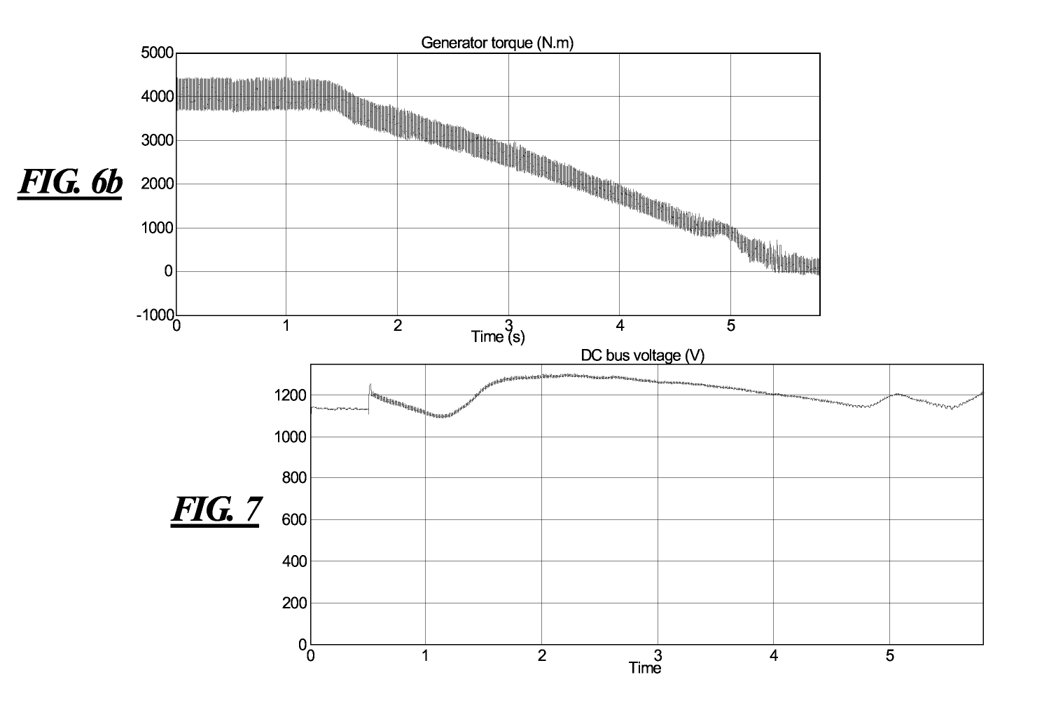

FIG. 7 in turn shows the DC voltage V_{dc} of the DC bus 32 after grid loss at half a second. The plot shows time in seconds on the X-Axis against voltage in volts on the Y-Axis. As can be seen, the DC voltage V_{dc} may be maintained substantially constant before and after the grid loss as the super capacitor 30 is charged.

Referring now to FIGS. 8A-8C, the super capacitor 30 power, voltage and current characteristics, respectively, are shown in a discharging mode at half a second after the grid is back online, in accordance with at least some embodiments of the present disclosure. FIG. 8A also shows the power characteristics of the generators 16 and the inverters of the GCUs 20. As shown, after the grid is back online, the super capacitor 30 discharges to the inverters, which maintain a substantially constant power, as illustrated by plot 180. As the power of the generators 16 decreases, as shown by plot 182, the power of the super capacitor 30, as shown by plot 184, increases by approximately the same proportion to enable the inverters to maintain a substantially constant power value.

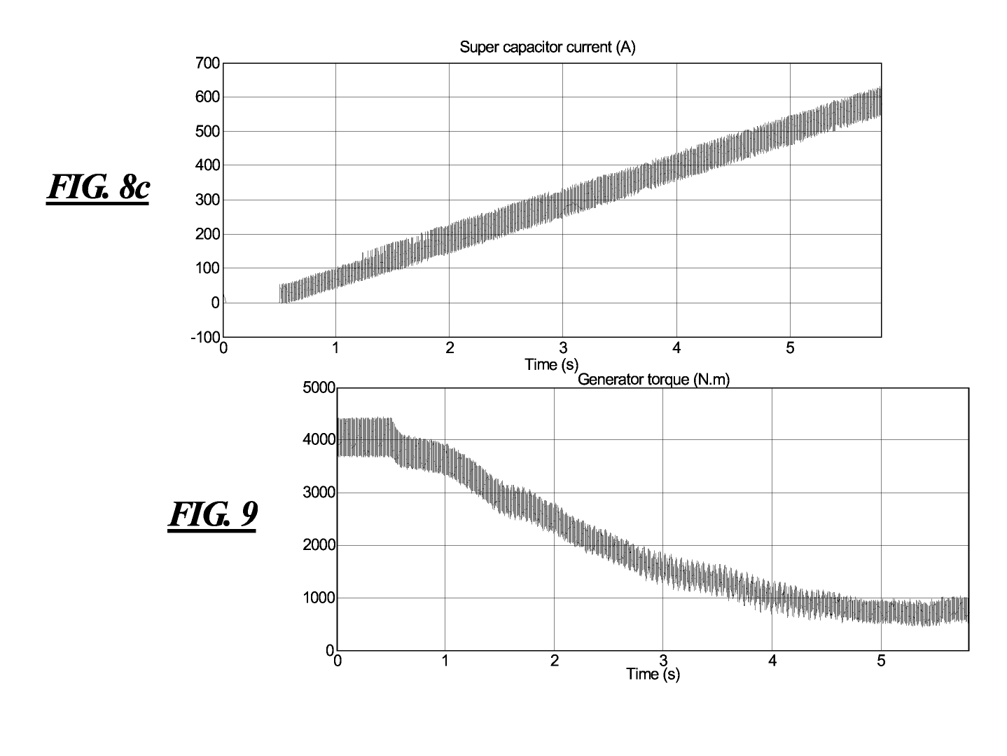

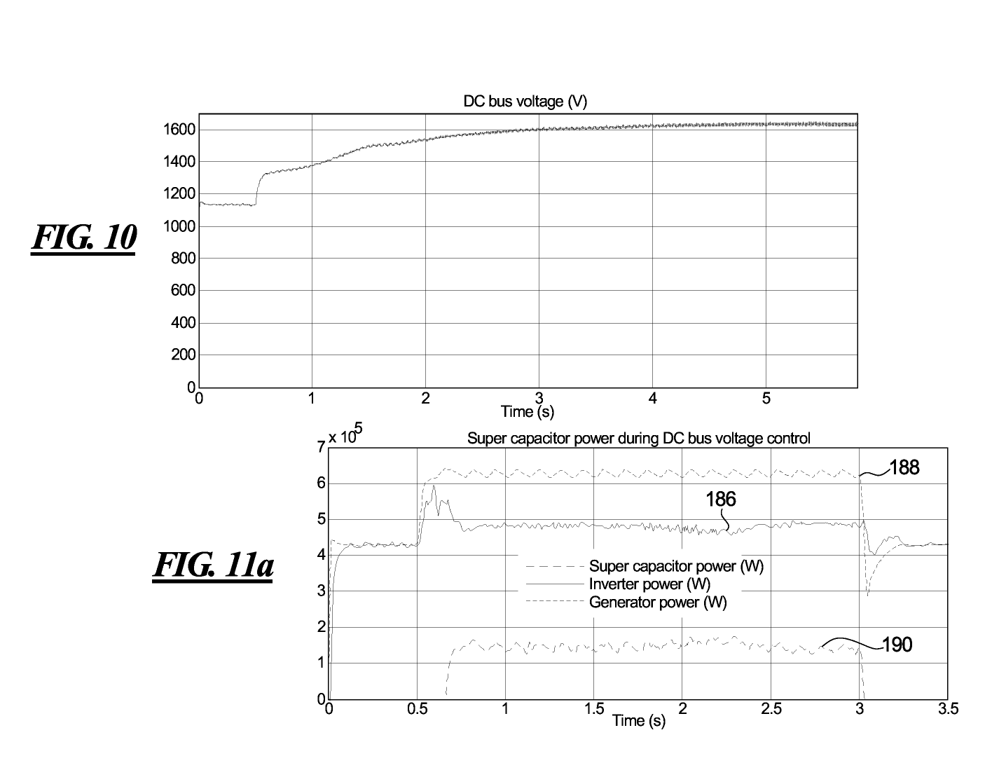

Relatedly, as shown in FIGS. 8B and 8C, the voltage V_{c} of the super capacitor 30 may decrease the super capacitor discharges (FIG. 8B), while the current may increase during the same time (FIG. 8C). FIG. 9 shows that the torque of the generators 16 may gradually decrease (since power decreases) during the discharging mode of the super capacitor 30, while FIG. 10 shows that the DC voltage V_{dc} of the DC bus 32 may increase slightly due to the DC bus receiving power from both the generators 16 and the super capacitor 30.

FIGS. 11A-12 show various electrical characteristics during conditions of over voltage at the DC bus 32. FIG. 11A shows the power characteristics of the super capacitor 30, the generators 16 and the inverters during over voltage at the DC bus 32. As shown, the graph plots time in seconds on the X-Axis against power in Watts (W) on the Y-Axis. The graph shows that when an over voltage at the DC bus 32 occurs, the inverters maintain a substantially constant power, as shown by plot 186, even though the power of the generators 16 increases (e.g., due to over speeding), as shown by plot 188. It is possible to maintain a substantially constant power of the inverters even when the generators 16 over speed by virtue of utilizing the super capacitor 30, which as shown by plot 190 may absorb the excess power from the generators to maintain the power of the inverters.

Referring now to FIGS. 11B and 11C, they illustrate voltage and current, respectively, of the super capacitor 30 during over voltage at the DC bus 32. Specifically, as shown in FIG. 11B, which plots time in seconds on the X-Axis and voltage in Volts on the Y-Axis, the voltage of the super capacitor 30 increases substantially linearly to indicate that the super capacitor is charged absorbing excess energy from the generators 16. Relatedly, the plot of FIG. 11C plots time in seconds on the X-Axis and current in Amperes on the Y-Axis. It can be seen from the plot of FIG. 11C that the current of the super capacitor 30 stays substantially constant as well during the time for which the super capacitor is charging.

FIG. 12 on the other hand shows the voltage V_{dc} of the DC bus 32 during conditions of over voltage. The plot, which has time in seconds on the X-Axis and voltage in Volts on the Y-Axis, shows that the voltage V_{dc} of the DC bus 32 may increase at around the same time (about half a second in this case) at which the power of the generators 16 increases (due to over speeding). The DC voltage V_{dc} of the DC bus 32 may stay a higher level (when the super capacitor 30 is absorbing the excess energy) until around three seconds, when the power of the generators 16 decreases as well (e.g., due to returning to normal speeds) to decrease the DC voltage V_{dc}.

### INDUSTRIAL APPLICABILITY

In general, the present disclosure sets forth a braking system having a DC chopper and a super capacitor to enable braking of the wind turbine during fault conditions. The braking system is operated under control by a control system based upon a variety of control signals that may be issued by the generator control unit(s) or the turbine control unit of the wind turbine. In response to the control signals, the super capacitor may be operated in a charging mode, discharging mode, idle mode and a system off mode.

By virtue of utilizing the braking system and using a DC chopper in combination with a super capacitor, the present disclosure provides several advantages. For example, by employing the super capacitor to store energy and to ensure a smooth torque transition from full load to no load, the required pitch rate of the blades during grid events or wind gust may be reduced, which in turn may reduce loads on the drive train and the tower section. The weight and cost of the drive train and the tower section may go down as well. Furthermore, the braking system may protect the inverters/converters within the GCUs against high open circuit voltage of the generator(s) occurring during over speeding or grid faults. This further allows utilizing high efficiency semi-conductor devices with lower voltage rating. IGBT switches with lower voltage ratings may in turn increase the inverter/converter efficiency by around one to one and a half percent (1.5%) and may be much more readily available off the shelf compared to traditional IGBT switches. Furthermore, compared to higher voltage rating IGBT switches, the lower voltage rating switches may be at least twenty percent (20%) cheaper.

In addition to all of the foregoing, the braking system may eliminate the need of using resistive elements as typical DC chopper circuits for dynamic braking systems. Resistive elements, as described above, generate heat and waste available inertial energy of the wind turbine, which may be utilized by employing a super capacitor as taught by the present disclosure. Thus, by implementing the braking system with super capacitor storage, a regenerative braking system for the wind turbine may be provided such that any absorbed energy by the super capacitor may be fed right back into the grid after the fault is cleared. The energy from the super capacitor may even be employed for providing any accessory power to various components of the wind turbine. Furthermore, the super capacitor does not require nearly the same level of cooling as conventional resistor braking systems. By employing the super capacitor, auxiliary systems for cooling may be smaller, may have less weight, may be less costly, and simpler to control.

While only certain embodiments have been set forth, alternatives and modifications will be apparent from the above description to those skilled in the art. These and other alternatives are considered equivalents and within the spirit and scope of this disclosure and the appended claims.

We claim:

1. A braking system for a wind turbine, comprising:
a DC chopper connected to a DC bus; and
a super capacitor capable of being connected to the DC chopper through a switch.

2. The braking system of claim 1, further comprising a backup resistor connected in parallel to the super capacitor.

3. The braking system of claim 1, wherein the DC chopper is a bidirectional DC-DC converter comprising:
two insulated gate bipolar transistor switches; and
a high current boost inductor.

4. The braking system of claim 1, wherein the DC chopper is operated under control of a control system and the DC chopper controls operation of the super capacitor.

5. The braking system of claim 4, wherein the control system generates a pulse width modulated signal based upon a duty cycle of the DC chopper to control the DC chopper.

6. The braking system of claim 1, wherein the super capacitor operates in one of charging mode, discharging mode, idle mode and system off mode.

7. The braking system of claim 1, wherein the super capacitor is connected to the DC chopper during a charging mode or a discharging mode.

8. The braking system of claim 1, wherein the super capacitor is disconnected from the DC chopper and a backup resistor is connected to the DC chopper in case of over voltage at the super capacitor.

9. A method of controlling power of a wind turbine during a fault condition, the method comprising:
providing a DC chopper connected to a DC bus, a super capacitor capable of being connected to the DC chopper through a switch and a control system for controlling operation of the DC chopper;
receiving a control signal by the control system; and
enabling an operating mode of the super capacitor based upon the received signal.

10. The method of claim 9, wherein receiving the control signal comprises receiving one of a BRAKE ON signal, an IGBT protection ON signal and a Capacitor Discharge ON signal, the BRAKE ON signal being received to facilitate a braking operation, the IGBT protection ON signal being received to protect the DC bus from over voltage and the Capacitor Discharge ON signal being received to facilitate discharge from the super capacitor.

11. The method of claim 10, wherein enabling an operating mode of the super capacitor when the BRAKE ON signal is received, comprises:
obtaining charging power and charging current for the super capacitor from a power requirement curve of the DC chopper;
enabling a current controller to determine a duty cycle of the DC chopper;
generating a pulse width modulated signal based upon the duty cycle;
connecting the super capacitor to the DC chopper in a buck converter configuration; and
charging the super capacitor through the DC chopper.

12. The method of claim 11, further comprising:
monitoring voltage of the super capacitor;
connecting a backup resistor to the DC chopper and disconnecting the super capacitor from the DC chopper in condition of super capacitor over voltage.

13. The method of claim 10, wherein enabling an operating mode of the super capacitor when the IGBT protection ON signal is received, comprises:
enabling voltage control by a voltage controller;
obtaining a maximum charging current of the super capacitor;
enabling a current controller to determine a duty cycle of the DC chopper;
generating a pulse width modulated signal based upon the duty cycle;
connecting the super capacitor to the DC chopper in a buck converter configuration; and
charging the super capacitor through the DC chopper.

14. The method of claim 10, wherein enabling an operating mode of the super capacitor when the Capacitor Dischrage ON signal is received, comprises:
receiving a current command from a turbine control unit of the wind turbine;
enabling a current controller to determine a duty cycle of the DC chopper;
generating a pulse width modulated signal based upon the duty cycle;
connecting the super capacitor to the DC chopper in a boost converter configuration; and
discharging the super capacitor through the DC chopper up to fifty percent of the stored energy of the super capacitor.

15. The method of claim 14, further comprising:
monitoring voltage of the super capacitor;
disconnecting the super capacitor when the discharge is complete;
entering an idle mode by the super capacitor.

16. The method of claim 10, further comprising:
receiving a SYSTEM OFF signal;
turning the DC chopper off in response to the SYSTEM OFF signal;
connecting a backup resistor to the super capacitor;
discharging the super capacitor through the backup resistor;
disconnecting the super capacitor when voltage of the super capacitor becomes less than or equal to two volts; and
turning the super capacitor off.

17. A wind turbine, comprising:
at least one generator connected at least indirectly to a DC bus;
at least one generator control unit connected at least indirectly to the at least one generator through the DC bus;
a braking system implemented within the at least one generator control unit, the braking system having a DC chopper connected to the DC bus and a super capacitor capable of being connected to the DC chopper through a switch; and
a control system implemented within the at least one generator control unit, the control system to control operation of the braking system.

18. The wind turbine of claim 17, wherein the super capacitor provides a dynamic braking function.

19. The wind turbine of claim 17, wherein the super capacitor provides a regenerative braking function.

20. The wind turbine of claim 17, further comprising a backup resistor connected in parallel to the super capacitor to prevent over voltage at the super capacitor.
